(19) United States
(12) Patent Application Publication
(10) Pub. No.: US 2008/0311330 A1
(43) Pub. Date: Dec. 18, 2008

(54) HOT EMBOSSING OF STRUCTURES

(75) Inventor: Ulrich Schindler, Furth/Bayern (DE)

Correspondence Address: HOFFMANN & BARON, LLP, 6900 JERICHO TURNPIKE, SYOSSET, NY, 11791, US

(73) Assignee: LEONHARD KURZ STIFTUNG & CO. KG, Furth (DE)

(21) Appl. No.: 12/136,540

(22) Filed: Jun. 10, 2008

(30) Foreign Application Priority Data
Jun. 14, 2007 (DE) 102007027999.1-45

(51) Int. Cl. B29C 65/48; B32B 5/18

(52) U.S. Cl. 428/40.2; 156/79

(57) ABSTRACT

There is described a process for the production of structures on substrates. At least one transfer layer (22) is transferred completely or region-wise on to the surface of the substrate (1) by an embossing film (2), in particular a hot embossing film, wherein the transfer layer (22) has regions which are formed by a binding agent. Open pores are produced in the transfer layer transferred on to the substrate (1), by the binding agent being expelled. A filler can then be introduced into the open pores. There is also described an embossing film for producing structures on a substrate.

### BACKGROUND OF THE INVENTION

The invention concerns a process for the production of structures such as conductor tracks and an embossing film for carrying out the process.

It is known, for the production of conductor tracks, for the conductor tracks to be applied by flat bed screen printing to a substrate, for example a silicon wafer intended for the production of a photovoltaic module, and then permanently joined to the substrate surface by sintering.

Flat bed screen printing is a time-consuming process and poorly suited to continuous manufacture and inexpensive mass production. In particular in flat bed screen printing the edges of the print image can break away during the printing operation and in particular when printing on abrasive media. That can result in unevenness in the print image of the conductor tracks of the electrodes and thus irregular electrical properties in respect of the electrodes.

DE 689 26 361 T1 describes a process and an apparatus for applying a thin film to a base plate by pressure and hot adhesive. The base plate can be for example an electronic circuit substrate of silicon, gallium-arsenide or the like. The application of vacuum is provided to avoid hollow spaces between the film and the base plate.

### SUMMARY OF THE INVENTION

The object of the present invention is to provide an improved process for applying structures to the substrate.

In accordance with the invention that object is attained by a process for the production of structures on a substrate, wherein it is provided that at least one transfer layer is transferred completely or region-wise on to the surface of the substrate by an embossing film, in particular a hot embossing film, wherein the transfer layer has regions in which the transfer layer contains particles and a binding agent and then open pores are produced in the transfer layer transferred on to the substrate, by the binding agent being expelled and porous structures thereby being produced on the substrate.

In addition the object is attained by an embossing film, in particular a hot embossing film, for producing structures on substrates, wherein it is provided that the embossing film has at least one transfer layer has regions in which the transfer layer contains particles and a binding agent, wherein open pores can be produced in the transfer layer by expelling the binding agent to produce porous structures which in particular are in the form of conductor tracks.

The process according to the invention therefore provides that the formation of structures such as conductor tracks is shifted substantially into a preceding manufacturing step, namely shifted into the manufacture of embossing films, in particular hot embossing films. The production of hot embossing films meets very high demands in terms of register accuracy of the structures, in which respect the structures can involve for example conductor tracks in the conventional sense and also electrodes or other electrically conducting regions or functional layers of a component or the like. The solution according to the invention now affords the possibility of also producing in a particularly simple fashion porous structure which for example are required for producing special electrodes or functional layers

Hot embossing films are preferably produced in a roll-to-roll process. In that case important functional parameters of the transfer layer such as material composition, thickness, structure and geometry can be set, while the tolerances which can be achieved are in the range of micrometers to nanometers. In the hot embossing operation, only a few parameters such as temperature, application pressure and residence time (embossing time, speed) have to be controlled to obtain a uniform quality for the transferred layers. In comparison flat bed screen printing is technologically much more complicated and expensive and more difficult to control since, as already mentioned, edges break away or solvents can escape from the print medium during the printing operation.

The binding agent can be both a binding agent comprising a substance or a mixture of substances, for example a binding agent mixture. The mixture of substances can consist of organic constituents but it can also be a mixture of organic and inorganic constituents. The particles which are bound in the binding agent matrix are preferably inorganic particles of a mean diameter of between 10 and 300 nm.

Further advantageous configurations are recited in the appendant claims.

It can be provided that the substrate is an inorganic material, in particular a silicon wafer, as is used for example for the production of solar cells.

It can be provided that a sintering process is carried out after transfer of the at least one transfer layer or between two successive embossing operations. With the sintering process it is possible for example to improve the adhesion of the transferred transfer layer on the carrier substrate, for example the silicon wafer and/or it is possible for organic binding agents or binding agents with a boiling point or sublimation point of less than or equal to the sintering temperature to be expelled from the transferred transfer layer. For example mutual diffusion of the mutually adjoining materials can be influenced with the parameters of sintering temperature and sintering time so that an interface layer is formed by mutual diffusion, in which the transfer layer and the carrier substrate are joined together by a connection involving intimate joining of the materials concerned. It is however also possible for only a final sintering process to be carried out between the operation of embossing of the last transfer layer. Preferably the sintering temperature is in that case so selected that the binding agents are expelled by the sintering process and the particles are joined to each other and to the carrier substrate by a connection involving intimate joining of the materials concerned.

It can further be provided that two or more sintering processes are performed at differing temperature and/or residence time.

It can be provided that the sintering temperature is set in the range of between 300° C. and 800° C.

It can preferably be provided that the sintering temperature is set in the range of between 450° C. and 550° C.

As tests have shown, for producing electrodes on silicon wafers, it can advantageously be provided that the sintering temperature is set to about 500° C. The sintering time can be between about 10 minutes and about 30 minutes, with the sintering temperature being maintained for about 5 minutes. It is possible to provide a cooling step after a sintering process or after a temperature treatment process, such as for example tempering.

It is also possible to adopt temperature ranges of a maximum of up to 190° C. for the heat treatment if the substrate is a thermoplastic material or the like temperature-sensitive material. The above-indicated high sintering temperatures are intended in particular for inorganic materials, for example for silicon wafers or for ceramics.

It is possible that the binding agent is chemically expelled after the transfer of the at least one transfer layer or between two successive embossing operations, for example by means of an etching agent or a solvent, or that the binding agent is washed out. By way of example acrylate compounds can be provided as the binding agent, which can be put into solution by means of methyl ethyl ketone (MEK). It is important in that respect that the (conducting) matrix is not destroyed or carried away and the particle bonding is maintained. The above-described sintering process can then be affected.

It can further be provided that the sintering process and/or the temperature treatment process is carried out in an atmosphere different from air, for example in a protective gas atmosphere such as nitrogen or argon to avoid reactions with atmospheric oxygen. On the other hand the atmosphere used in the temperature treatment process can be intended to deliberately and specifically trigger chemical reactions, for example to promote the formation of an oxide layer or to convert organic constituents into the gaseous phase.

It is also possible to provide one or more cleaning phases between the one or more sintering processes and/or temperature treatment processes. The cleaning phases can be provided for example to remove the binding agent or residues thereof, as described hereinbefore. The cleaning phases can further be provided to subject the substrate surface and the surface of the transfer layer which is transferred on to the substrate to the action of gases and/or liquids and in so doing to condition them.

The temperature regime and/or the residence time regime in the cleaning phases or in the cleaning phase can be varied to achieve an optimum cleaning and/or conditioning effect.

It can further be provided that cleaning phases are also implemented after one or more embossing operations.

It is also possible for chemical process steps which can partially or completely initiate dissolution for example of layers to be carried out after one or more embossing operations, in which respect it is possible to set numerous process parameters such as for example the chemical composition of the substances brought into contact with the silicon wafer, the residence time of the added chemical substances, the process temperature and the process pressure.

It can further be provided that a filler is introduced into the open pores of the transfer layer transferred on to the substrate. That filler can be provided to modify the chemical and/or physical properties of the transferred transfer layer for the desired purpose of use. The filler can be a substance or a mixture of substances.

It is possible for the filler to be an electrically conductive or a semiconducting material. It can therefore be provided that the structure according to the invention is made of electrically non-conductive particles and an electrically conductive filler is introduced into the pores of the electrically non-conductive structure.

It is also possible for the filler to be a catalytically acting material.

It is also possible for the filler to form a layer on the surface of the pores, which does not completely fill up the pores. Such a layer can be for example of a thickness of some nanometers and may cover an area which can be a multiple larger than the surface of the transfer layer which is transferred on to the substrate. As stated above for example the pore surface can be coated with a catalyst. The pores are preferably of a mean diameter of between 500 and 5000 nm. The layer thickness of the filler layer applied to the pore surface can be between 2% and 20% of the mean pore diameter.

It can further be provided that a porous conductor track or electrode is formed, in that, in a region in which the transfer layer is transferred completely or region-wise on to the surface of the substrate by the embossing film, the transfer layer contains electrically conductive particles as the particles in question, and open pores are then produced in the transfer layer transferred on to the substrate, by the binding agent being expelled and further porous, electrically conductive structures being thereby formed on the substrate.

It is also possible for a porous conductor track or electrode to be formed, by a procedure whereby the at least one transfer layer is in the form of an electrically non-conducting transfer layer and is transferred completely or region-wise on to the surface of the substrate by the embossing film, open pores are produced in the transfer layer transferred on to the substrate by the binding agent being expelled, and an electrically conductive or an electrically semiconducting material is introduced as a filler into the open pores.

Equally it is possible to form catalytically acting layers (as set forth hereinbefore), by the transfer layer being formed from catalytically acting particles and a binding agent and by the binding agent being expelled after transfer of the transfer layer. Such a porous catalyst layer has a high level of effectiveness, by virtue of its large surface area. It is however also possible for the surface of the pores to attain a catalytic action only by way of a filler—which comprises a catalytically acting material.

It can be provided that the geometrical structure and/or a conductivity structure of the structure is or are established by the configuration of the embossing film and/or an embossing punch. It can for example be provided that an embossing film with an electrically conductive transfer layer over its full surface area is used, and the transfer layer is structured upon transfer on to the substrate by a structure punch. In that case the surface structure of the structure punch determines the outline contours of the transferred transfer layer, in which case those edges can be sharp. The regions of the transfer layer, that are not required, remain on the embossing film after the embossing operation and are discarded.

It is possible for the transfer layer to be transferred by stroke embossing.

It is further possible for the transfer layer to be transferred by rolling embossing.

It is also possible for the structures to be produced in more than one embossing step. It can therefore be provided that for example conductor tracks are embossed in portion-wise manner.

It can further be provided that transfer layers of different material and/or involving different electrical conductivity and/or thickness and/or geometrical structure and/or with a different cross-sectional profile are successively transferred. The properties of the conductor tracks can be varied in many different ways in that fashion. In particular it is possible for them to be varied region-wise, for example it is possible for regions to be formed as electrodes and regions to be formed as conductor tracks or the like. The conductor tracks can for example connect electrodes of photovoltaic cells together. In that way photovoltaic modules can be formed by series and/or parallel circuits of photovoltaic cells.

It is further possible for a conductivity gradient to be produced in the structure by transferring two or more transfer layers, for example if the individual transfer layers involve differing conductivities and internal resistances.

It can be provided that the geometrical structure and/or a conductivity structure of the structure is or are set by the configuration of the embossing punch and/or the embossing film, as described hereinbefore. It can therefore be provided for example that conductor track regions are transferred by an embossing film having a structured transfer layer and/or conductor track regions are transferred by means of a structure punch by an embossing film having a transfer layer over the full surface area thereof.

It is possible for both methods to be combined together. It is possible for example to provide an embossing film, the transfer layer of which has both structured and also unstructured regions and also an embossing punch which is in the form of a structure punch in region-wise manner.

It can further be provided that the adhesion of the structure is locally varied by transferring two or more transfer layers. The differing adhesion can be afforded by different structuring of the transfer layer and/or a different composition for the transfer layer and/or by one or more layers of the embossing film. It is possible for example to provide layers which act as an adhesive layer or as a separation layer or which give rise to a different adhesion action as a consequence of a sintering process.

It is further possible to use embossing films with carrier layers which differ from each other in at least one property, for example thickness and/or flexibility and/or substance composition.

It can further be provided that the transferred transfer layer is embossed with at least one protection layer, for example if it is a conductor track or an electrode. The choice of the protective layer and the manner of applying the protective layer can have a decisive influence on the service life and good-quality functioning of the product which is manufactured with the process according to the invention. In that respect, besides the physical and/or chemical properties of the transferred protective layer, the choice of the adhesive layer which provides for bonding of the protective layer is significant. As already stated hereinbefore those important parameters can already be substantially set in manufacture of the embossing film so that lower demands can be made on the embossing procedure itself and thus the manufacturing costs can be low, even when dealing with small numbers of items.

It is also possible for a transfer layer having an optically variable element to be applied as a concluding layer. The optically variable element can be for example a corporate logo or the like which at the same time can be used as an authenticity certificate if the optically variable element is in the form of a security element (hologram, diffraction grating or the like).

Further advantageous configurations are directed to the embossing film.

The carrier film of the embossing film preferably comprises a flexible plastic film of a thickness of less than 200 μm, preferably less than 50 μm. The carrier film can thus be made from a plastic film of a thickness of preferably between 12 μm and 150 μm, further preferably between 12 μm and 50 μm. By way of example the material of the plastic film can be PET (polyethylene terephthalate) or BOPP (biaxially oriented polypropylene).

It can be provided that the particles are electrically conductive particles.

It can be provided that the at least one transfer layer is formed from a mixture of particles and the binding agent, in particular binding agent particles. As already indicated a number of times in another connection, it is possible with the process according to the invention and with the embossing film according to the invention, for the production of the structures, for example conductor tracks, to be already ‘tailor-made’ in manufacture of the embossing films and at the same time to be shifted into a mass-production process.

It can be provided that the electrically conductive particles are metal particles. Those particles are preferably of a mean diameter of between 10 and 50 nm and comprise silver or copper or an alloy of those metals. On the basis of metal particles, it is not only possible to manufacture conventional metallic conductor tracks and/or electrodes, but it is also possible to manufacture hybrid conductor tracks and/or electrodes, that is to say with non-metallic conducting and/or semiconducting components. By way of example metallic particles can form a matrix in which non-metallic particles are embedded. In that respect for example the conductivity of the transferred transfer layer can be set by means of a variation in the mixing ratio. It is however also possible for the components which are added to the metallic particles to be expelled from the transfer layer after the application thereof, and thus for example to produce a porous electrode and/or an electrode in matrix form, or it is possible for the intended filler to be introduced into the porous transfer layer after application thereof and after expulsion of the above-mentioned component, or it is possible to introduce a plurality of filling components, as described hereinbefore. The filler or the filling components can be for example substances which would be destroyed during the sintering process and therefore it is only thereafter that there is the possibility of binding them in place.

It can further be provided that the electrically conductive particles are carbon nanotubes. The term ‘carbon nanotubes’ denotes here on the one hand carbon nanotubes per se, and also further other materials, the properties of which are substantially determined by their nanostructure. Those particles which are preferably formed from carbon and which exhibit that property are of dimensions in that respect, which are smaller than the wavelengths of visible light.

It can further be provided that the electrically conductive particles are particles of at least one electrically conductive polymer.

It is also possible for the particles to be semiconducting particles. In that case the particles can comprise an inorganic or organic semiconducting material, for example an Si alloy. Those particles are preferably of a mean diameter of about 50-100 nm.

In an advantageous configuration it can be provided that the semiconducting particles are electrically semiconducting TiO₂ particles, in particular TiO₂ nanoparticles. In that respect, that layer formed by way of one or more transfer layers, including further process steps, can be used in the production of a photovoltaic Grätzel cell (liquid cell).

The semiconducting particles can also be particles of at least one semiconducting polymer. Structures of conducting and/or semiconducting polymers can be provided for example for the production of photovoltaic cells on a polymer basis (OPV) or photovoltaic dye-sensitised cells (DSSC).

It can further be provided that the particles are electrically non-conducting particles. Those particles preferably comprise an inorganic, non-electrically conductive material, for example glass balls. It is however also possible for those particles to comprise an organic, electrically non-conducting material, for example inter alia PET (polyethylene terephthalate). When the binding agent is expelled by means of a sintering process or a heat treatment, the material used for the particles is preferably materials which break down or evaporate at most 10%, preferably at most 5%, most preferably not at all, at the sintering temperature or at the process temperature of the heat treatment. In that respect, the material used for the particles can be inorganic substances which form framework structures, such as for example SiO₂, silanes. In addition it is also possible for suitable particles to contain siloxanes and/or organic materials. A suitable material for the particles is in particular thermosetting materials such as for example polyesters, formaldehyde resins, epoxy resins, polyurethane and/or copolymers and/or mixtures thereof. The thermosetting materials preferably have fluorine groups, aromatic groups and/or heterocycle groups. The thermosetting materials used can also be for example polyphenylene sulfide, polyphenylene sulfones and polyethene ketones. In that case the particles are preferably used in a form such that they form framework structures of the above-defined materials, either prior to and/or after the sintering process.

The particles can for example form a support matrix for receiving fillers. The particles are preferably of a mean diameter of between 100 and 300 nm, in which respect however it is also possible to envisage other sizes or mixtures of sizes.

It is also possible for the particles to be catalytically acting particles, for example consisting of platinum, as stated hereinbefore. The particles are preferably of a mean diameter of between 20 and 50 nm.

It is possible for the particles to be of approximately equal dimensions. The term ‘approximately equal’ dimensions is used to mean that the dimensions can fluctuate about a mean value, and can be for example in a Gaussian distribution.

It is however also possible for the particles to be of different dimensions. The reference to ‘different dimensions’ is used to mean that the dimensions differ from each other to such an extent that they can be classified at least in two groups of sizes, for example as particles involving dimensions in the nanometer range and particles involving dimensions in the micrometer range. In that respect the particles of one group of sizes can again be present in a Gaussian distribution or in another distribution—for example in a bimodal distribution.

It can further be provided that the concentration by volume of the particles in the at least one transfer layer is not constant. The concentration by volume can be set for example by a variation in the proportion of binding agent in manufacture of the transfer layer or by partial mixture separation of the transfer layer while still liquid by the action of the force of gravity, as is to be observed for example in relation to applications of paint on vertical walls.

It can be provided that the binding agent can be expelled by a temperature process. The reference to ‘can be expelled’ is preferably used to mean that the binding agent has a boiling point and/or sublimation point and/or a decomposition temperature of less than or equal to the sintering temperature. In regard to the sintering temperature attention is directed to the foregoing description. By way of example sublimating substances can be considered as the binding agents which can be expelled by a thermal process. In that respect the binding agents used are preferably materials, in particular organic polymers, which at the sintering temperature or the process temperature for the heat treatment, break down and/or evaporate to at least 90%, preferably 95%. In that respect for example organic polymers can be used as binding agent for the above-described inorganic, conductive, non-conductive and semiconducting particles and for the above-described organic, electrically conductive, non-conductive and semiconducting particles. Suitable organic polymers are in particular thermoplastic materials such as for example polyethylene, polypropylene, polystyrene, polyvinyl chloride, polyacryl nitrate, polyamides, polyester, polyacrylates, acrylate compounds and/or poly(meth)acrylates. For example cellulose compounds are also suitable as organic polymers.

Furthermore solvents can also be added to the binding agent. The concentration by volume of the particles with respect to the binding agent is preferably between 40 and 80% by volume. The porosity of the structure is adjusted by the concentration by volume of the binding agent. The higher the concentration by volume selected for the particles, the corresponding smaller is the proportion by volume of pores in the structure.

It is possible that the temperature process at the same time triggers a chemical process which converts an initially chemically non-dissolvable binding agent into a chemically dissolvable binding agent. It is possible to provide for example oxidisable or thermally crackable binding agents.

It can also be provided that the binding agent can be expelled by a chemical process which takes place substantially at room temperature. That can involve for example a binding agent which is chemically dissolvable in a solvent, such as acrylates or an acrylate mixture.

It can be provided that the embossing film has one or more release layers. The release layer can be for example a lacquer or a composition comprising 20% by volume of polyacrylate, 70% by volume of methyl ethyl ketone and 10% by volume of butyl acetate which in the dried condition forms a layer of about 1 μm in thickness.

It can further be provided that the embossing film has one or more priming layers which can also be provided only partially. The priming layer improves the adhesion of the transferred transfer layer. It can be for example an adhesive layer, preferably a layer of a hot melt adhesive, UV-hardenable adhesive or cold adhesive, or a layer which is specifically matched to the substrate or the previously transferred transfer layers and which preferably adheres thereto. The priming layer involved can be for example a lacquer, for example involving a composition of 26% by volume of binding agent, for example polyester or adhesive, 4% by volume of SiO₂, 50% by volume of methyl ethyl ketone and 20% by volume of high-boiling substances such as for example cyclohexanone. The application weight of the priming layer can be for example between 0.5 and 0.8 g/m², which gives a layer thickness of between about 500 and 800 nm.

### BRIEF DESCRIPTION OF THE DRAWINGS

The invention is now described in greater detail with reference to the Figures in which:

FIGS. 1a, b and c show diagrammatic views in section of manufacturing steps of a first embodiment,

FIGS. 2a, b and c show diagrammatic views in section of manufacturing steps of a second embodiment,

FIGS. 3a, b and c show diagrammatic views in section of manufacturing steps of a third embodiment,

FIG. 4 shows a diagrammatic view in section of a fourth embodiment,

FIG. 5 shows a diagrammatic view in section of a fifth embodiment,

FIG. 6 shows a diagrammatic view in section of a sixth embodiment,

FIGS. 7a through e show diagrammatic views in section of manufacturing steps of a seventh embodiment,

FIG. 8 shows a diagrammatic view in section of an eighth embodiment,

FIG. 9 shows a diagrammatic view in section of a ninth embodiment, and

FIG. 10 shows a diagrammatic view in section of a tenth embodiment.

### DETAILED DESCRIPTION OF THE PREFERRED EMBODIMENTS

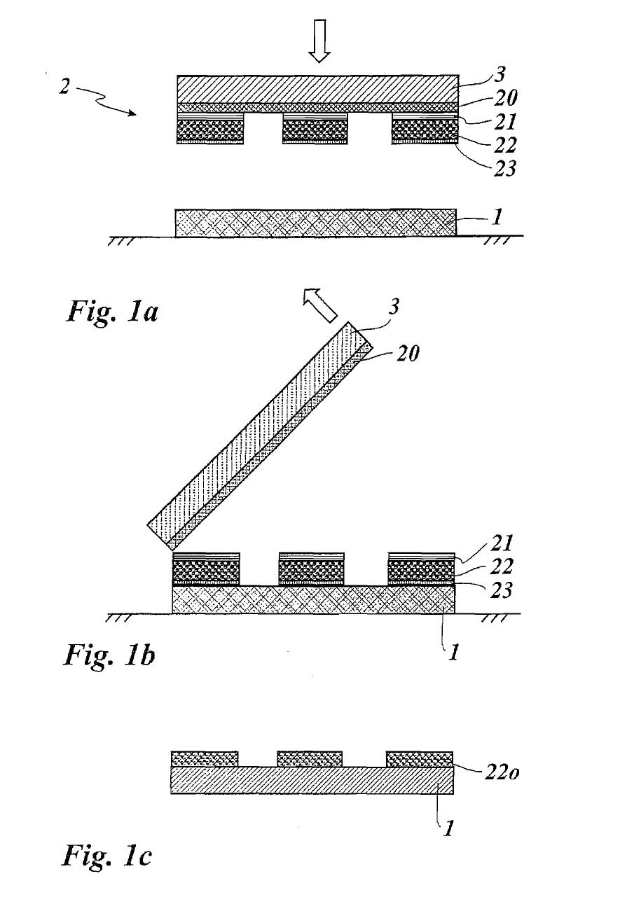

FIG. 1 shows a carrier substrate 1 intended for the application of an electrode layer by means of hot embossing. By way of example the following can be provided as the carrier substrate 1:
metal films of a thickness of between 50 and 150 μm, possibly provided with a non-conducting cover layer;
glass carriers of a thickness of about 1 mm;
doped silicon wafers, for example for producing a photovoltaic cell or a photovoltaic module, or
plastic films.

A hot embossing film 2 is formed from a carrier film 20, a release layer 21, an electrically conductive transfer layer 22, and a priming layer 23, the hot embossing film 2 being carried on a heated embossing punch 3. The surface temperature of the embossing punch 3 can be for example between 180° C. and 190° C.

The carrier film 20 can be for example a plastic film of between 12 and 150 μm, preferably between 12 and 50 μm. The plastic film can for example comprise PET or BOPP. In the FIG. 1 embodiment this is a PET film of between 19 and 23 μm in thickness.

The release layer 21 can be formed for example from a lacquer of the composition of 20% by volume of polyacrylate, 70% by volume of methyl ethyl ketone and 10% by volume of butyl acetate, and in the dried condition can form a layer of about 1 μm in thickness.

The electrically conductive transfer layer 22 comprises a proportion of binding agent and the conductive component. The transfer layer 22 can be a lacquer layer which is formed from a lacquer which was of the composition of 56% by volume of a metallic component in powder form such as gold, silver, aluminum, copper or an alloy of those materials, 19% by volume of binding agent and 25% by volume of solvent, the lacquer layer in the dried condition forming a transfer layer of a thickness of about 25 μm. The binding agent used can be for example acrylate compounds while the solvent used can be for example mixtures of ketones and aromatics. However the transfer layer may also be a lacquer layer in which TiO₂ is used instead of the metallic component, in which case the composition of 25% by volume of TiO₂, 10% by volume of binding agent and 65% by volume of solvent can be selected. The stated binding agents form the first filler arranged between the electrically conductive regions of the transfer layer 22. The transfer layer 22 can be applied to the hot embossing film in known manner by printing.

The priming layer 23 is also formed from a lacquer, for example of the composition of 26% by volume of binding agent, for example polyester or adhesive, 4% by volume of SiO₂, 50% by volume of methyl ethyl ketone and 20% by volume of high-boiling material such as for example cyclohexanone (boiling point 155° C.). The application weight of the priming layer can be for example between 0.5 and 0.8 g/m². The SiO₂ particles in the priming layer serve as spacers when winding up the film and prevent ‘blocking’ or unwanted lacquer transfer on to the rear side of the carrier film 20. The priming layer can also be an adhesive layer, preferably a layer of a hot melt adhesive, a UV-hardenable adhesive or a cold adhesive.

Manufacture of the hot embossing film can advantageously be effected in a roll-to-roll process, in which respect the above-mentioned layers can all be transferred by printing processes.

The rear side of the carrier film 20 faces towards the front side of the embossing punch 3. The front side of the hot embossing film 2 which at the same time is the front side of the priming layer 23 faces towards the top side of the carrier substrate 1 and is brought into contact therewith during the embossing process. In that case the priming layer 23 acts as a bonding layer or as an adhesive layer. By means of the embossing process the transfer layer 22 is transferred on to the top side of the silicon wafer 1, as shown in FIG. 1b, and there forms conductor tracks which can be used as electrode regions and/or contact regions and/or other electrically conductive regions.

After transfer of the transfer layer 22 the embossing punch 3 is lifted off, with the release layer 21 assisting with separation of the transfer layer 22 from the hot embossing film 2.

FIG. 1c now shows the carrier substrate 1 with a post-treated transfer layer 22o in which the binding agent is removed. The binding agent can be removed from the transfer layer 22 which has been transferred on to the substrate 1, in a sintering process. It can be provided for example that sintering is effected for between about 10 and 30 minutes and in that operation a temperature of about 500° C. is maintained for about 10 minutes. In that case organic constituents of the release layer, the transfer layer and the adhesive layer are expelled, in which case they pass into the gaseous phase and, in respect of the non-volatile constituents of the transfer layer, a bond is produced between the particles and the substrate. The particles of the component which is not expelled are joined together in surface relationship so that consequently open pores are formed. It is also possible for the binding agent to be only partially removed during the sintering process and for the residue to be removed in a subsequent wet-chemical process with subsequent cleaning and/or drying. It is also possible in this connection to entirely dispense with the layer 23, more specifically, if the binding agent in the transfer layer is sufficient to ensure a bond to the substrate during the embossing operation. In this connection it is also possible for the layer 23 not to go into the gaseous phase, more specifically if the residence time or the temperatures during the sintering process have not been selected sufficiently high.

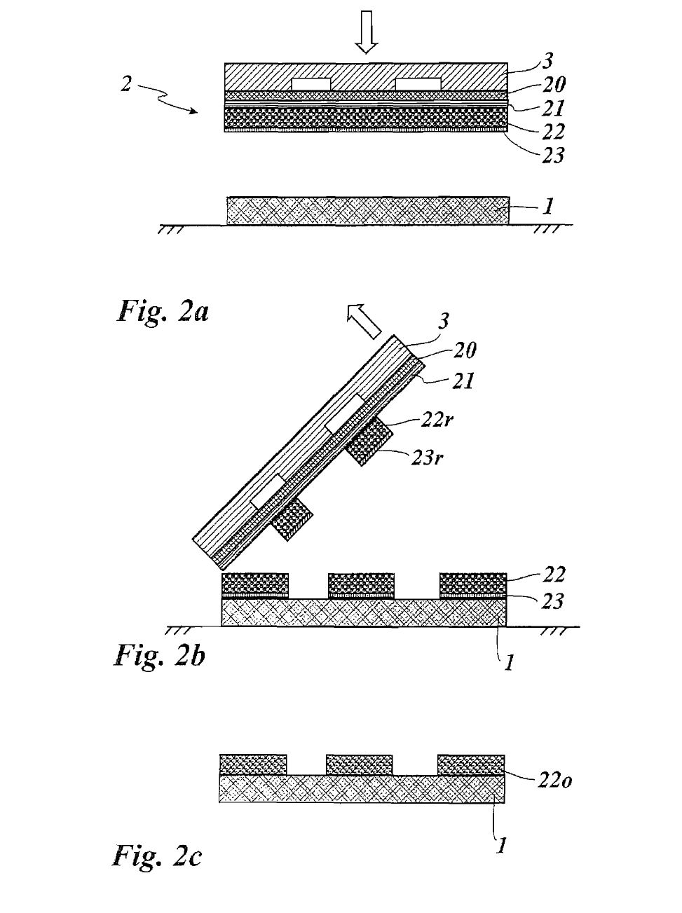

FIGS. 2a through c now show a second embodiment in which the transfer layer 22 of the hot embossing film 2 is provided over the entire surface area (FIG. 2a). The embossing punch 3 has a surface structure corresponding to the conductor structure to be transferred, wherein the regions between the conductor tracks are of a recessed nature so that the surface of the embossing punch 3 is in contact with the hot embossing film only in the regions of the conductor tracks.

As shown in FIG. 2b, in the embossing operation, of the transfer layer 22, only the regions arranged on the raised regions of the embossing punch 3 are transferred on to the silicon wafer 1. Upon separation of the embossing punch 3 from the silicon wafer 1 those regions remain on the carrier substrate 1. Regions 22r of the transfer layer 22, that are arranged over the recessed regions of the embossing punch 3, remain on the hot embossing film 2 and are detached therewith when the punch 3 is lifted off.

The process shown in FIGS. 2a through c can enjoy advantages for test implementations and small-scale series and can advantageously be used whenever the manufacturing costs of the embossing punch 3 are lower than the manufacturing costs of a hot embossing film provided with a structured transfer layer. As described hereinbefore it can be provided that the release layer is at least partially transferred and for example goes into the gaseous phase in a subsequent sintering procedure. The partially transferred priming layer can be intended to improve the adhesion of the regions of the transfer layer, that are transferred on to the carrier substrate 1, so that the regions of the transfer layer, that are arranged under the cut-out regions of the embossing punch 3, can be removed without any problem.

In the FIG. 2c embodiment the priming agent has been removed in a sintering process. It can for example be provided that sintering is effected for between about 10 and 30 minutes and in that case a temperature of about 500° C. is maintained for about 10 minutes. In that case organic constituents of the transfer layer, in particular the binding agent, are expelled and pass into the gaseous phase.

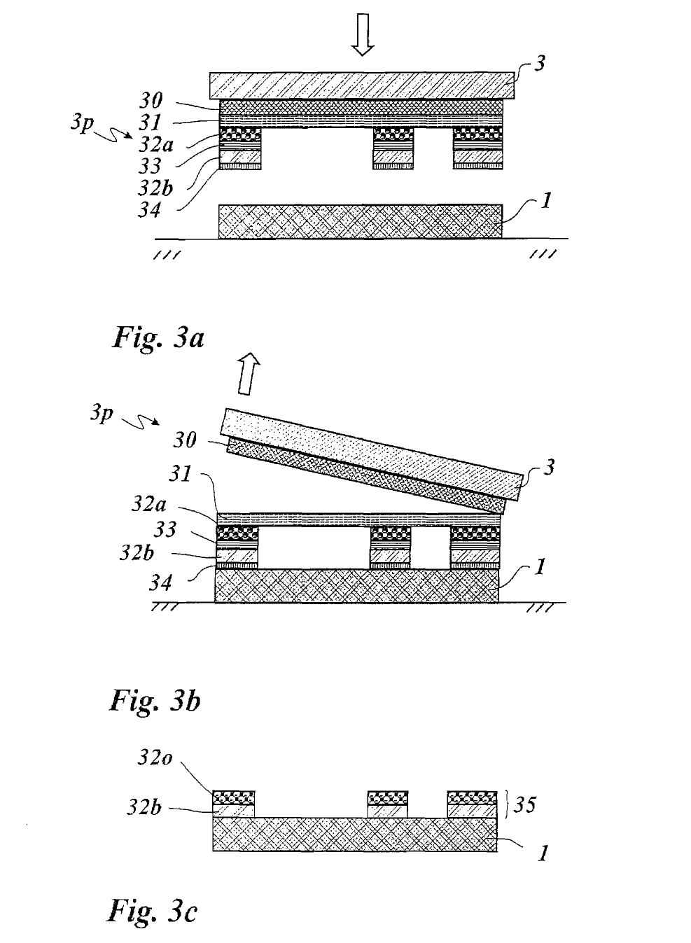

FIGS. 3a through c now show process steps for building up multi-layer electrode layers.

FIG. 3a shows a hot embossing film 3b which is pressed with the embossing punch 3 on to the carrier substrate 1. The hot embossing film 3b is formed from a carrier film 30, a release layer 31, a first electrically conductive transfer layer 32a, a possible intermediate layer 33 (for example for improving adhesion during the printing operation), a second electrically conductive transfer layer 32b and a priming layer 34.

In the hot embossing operation the two transfer layers 32a, 32b are transferred jointly, as shown in FIG. 3b, wherein a sintering operation is again carried out after the transfer procedure, the sintering operation permanently connecting the two transfer layers both to each other and also to the surface of the carrier substrate 1. The organic constituents of the release layer 31, the intermediate layer 33 and also the priming layer 34 are expelled by the sintering process.

The release layer 31 is so set that it does not remain on the hot embossing film 3p but on the electrode layer. The release layer 31 is therefore only removed in the sintering step.

FIG. 3c now shows the carrier substrate 1 with a structured electrode layer 35 comprising a lower layer portion 32b and an upper layer portion 32o. The carrier substrate 1 can be for example a doped silicon wafer provided for building up a photovoltaic cell or a photovoltaic module. In the FIG. 3c embodiment the lower layer portion 32b is in the form of a homogeneous, non-porous, partly transparent electrode layer. The upper electrode layer 32o is in the form of an open-pore electrode layer, the pores of which can be partially or completely filled with a filler in a further process step. It is to be mentioned in this connection that the porosities can be adjusted not only by the proportion of the volatile component but also by the melting characteristics of the non-volatile component and the choice of the sintering temperature.

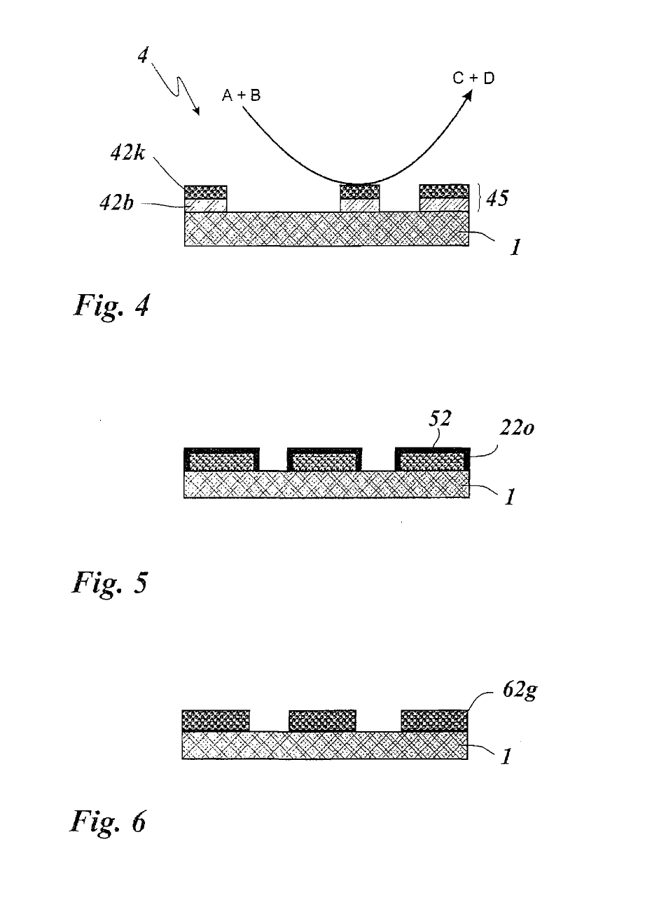

FIG. 4 now shows an entirely different possible use of porous structures on a for example inert carrier. Disposed on the front side of the carrier substrate 1 is a porous matrix 45 formed from two transfer layers 42b and 42k, of a similar structure to that shown in FIG. 3c. In this case the upper porous transfer layer 42k acts as a catalyst for a chemical reaction. The transfer layer 42k is of a very large surface area. The transfer layer 42k can be formed from a catalytically acting material but it can also be provided that the pores in the transfer layer 42 are coated with a catalytically acting filler at the surface—in order not to lose the enlarged surface area—. As diagrammatically shown in FIG. 4 the chemical equilibrium is shifted from the starting components A and B to the final components C and D.

FIG. 5 now shows a further embodiment in which, starting from the intermediate step shown in FIG. 2c, the electrode layer 22o is covered with a galvanically applied metallic layer 52.

FIG. 6 shows a sixth embodiment in which, starting from the intermediate step shown in FIG. 2c, produced on the carrier substrate 1 is an electrode layer 62 which for example is in the form of an open-pore metallic layer of copper or silver which in itself and also in relation to the substrate, has acquired good adhesion due to the sintering process and the pores of which are filled with the filler PEDOT/PSS. Such an electrode configuration can be provided for example for building up photovoltaic cells or modules based on organic semiconductor layers.

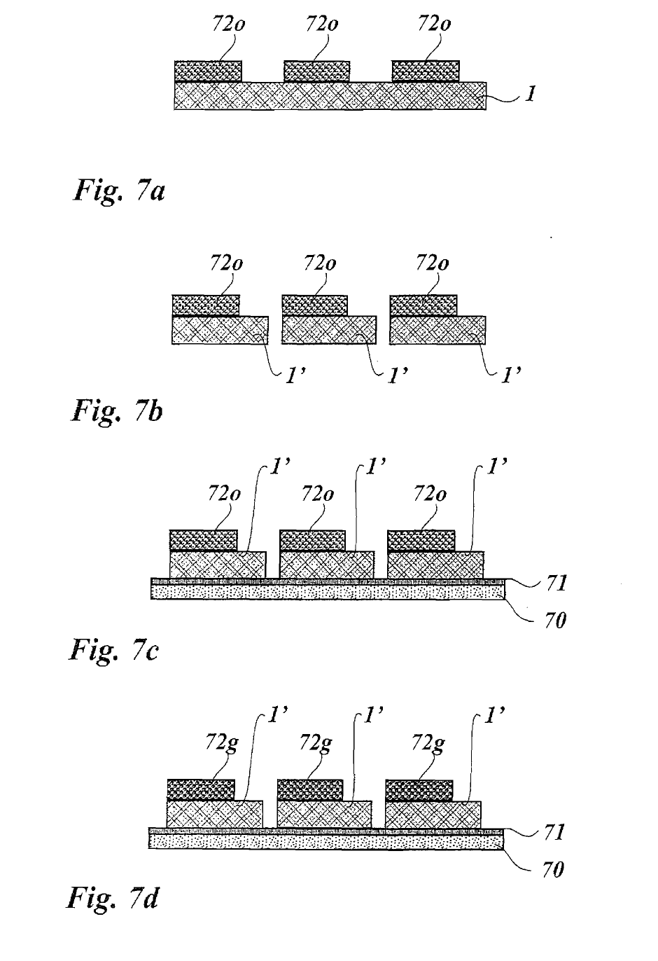

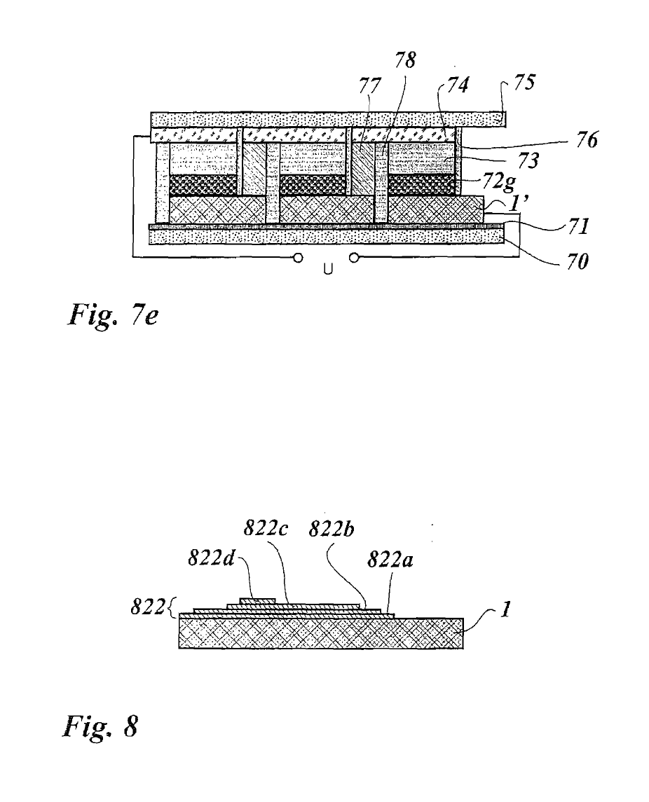

FIGS. 7a through 7e now show manufacturing steps for building up a photovoltaic cell or module on the principle of the dye-sensitised cell.

FIG. 7a, as a starting configuration similar to the embodiment shown in FIG. 2c, on the carrier substrate 1, shows an open-pore electrode layer 72o which for example is in the form of a metallic layer of copper or silver of a thickness of about 60 μm. In this embodiment the carrier substrate 1 is an electrically conductive substrate, for example a metallic substrate of titanium film with gold vapor deposited thereon, of a total layer thickness of about 20 μm.

The transfer layer 72o is then impregnated or coated with titanate by the application for example of a tetraalkylate solution. The titanate is converted into TiOₓ in a subsequent temperature process at about 120° C. and in the presence of high air humidity. After that step the pores of the open-pore electrode layer are now coated with TiOₓ. In this embodiment for example the pores are of a mean diameter of between 20 and 50 nm. The TiOₓ forms on the pore surface a layer of a layer thickness of about 3 nm. It can however also be provided that the transfer layer 72o is formed directly from a TiO₂ matrix which after the sintering process forms the porous TiO₂ structure.

The carrier substrate 1 is now cut into strips 1′ which each involve a region of the transfer layer 72o, as shown in FIG. 7b.

The strips 1′ are then applied by lamination to an electrically non-conductive carrier film 70, for example a 19 μm thick PET film, the top side of which is coated with an adhesive layer 71 (FIG. 7c). The adhesive layer involved can be for example an acrylate compound with an application density of 2 g/m².

The coated electrode layer 72o is then impregnated with a dye solution and converted into an electrode layer 72g as shown in FIG. 2. The dye solution can be for example a solution of ruthenium 2,2 AE-bipyridyl-4,4 AE-dicarboxylate 2(NCS)2.

FIG. 7e now shows a finished electrochemical dye-sensitised cell 7 in which firstly, starting from the structure shown in FIG. 7g, a respective redox electrolyte layer 73 which can be for example a solution of iodine and potassium iodide is introduced into the regions, which are delimited from each other, of the electrode layer 72g. The redox electrolyte layer 73 can be about 30 μm in thickness.

Arranged over the redox electrolyte layer 73 is a transparent electrode 74 covered by a transparent cover layer 75. Perpendicularly arranged insulator layers 76 and 78 separate the photovoltaic cells disposed on the carrier film 70 from each other, wherein the insulator layer respectively covers one of the ends of the mutually superposed electrode layer 72g, redox electrolyte layer 73 and transparent electrode 74. Provided between the two insulator layers 76 and 78 are connecting portions 77 extending perpendicularly for electrically connecting adjacent photovoltaic cells. The electrically conducting connecting portion 77 is arranged on the side of the insulator layer 76, that is remote from the photovoltaic cell, and connects the electrode layer 72g of the one adjacent photovoltaic cell to the transparent electrode 74 of the other adjacent photovoltaic cell. The insulator layer 78 covers over the ends, remote from the insulator layer 76, of the carrier substrate 1′, the electrode layer 72g and the transparent electrode 74. The insulator layers 76 and 78 can each be in the form of adhesive layers for sealing off the photovoltaic cells. Inter alia durability and service life of the above-described photovoltaic module 7 can depend on permanently sealing off the photovoltaic cells. Upon irradiation of the module, for example with sunlight (for example AM1.5=standard spectrum), an electrical voltage U can be taken off between the strips 1′ which are cut out of the conductive carrier substrate 1 (FIG. 1) and the transparent electrode 74.

FIG. 8 now shows an eighth embodiment in which a transfer layer 822 formed from four transfer layer portions 822a through 822d is transferred on to the carrier substrate 1. In the FIG. 8 embodiment the transferred transfer layer portions 822a through 822d are structured differently so that for example a conductivity profile can be produced in the conductor tracks or electrode regions.

It can however also be provided that the transfer layer portions 822a through 822d are made from different materials. For example the uppermost, outward transfer layer portion 822d can be of a particularly weather-resistant nature, the innermost transfer layer portion 822a can be of a particularly firmly adhering nature and the two interposed transfer layer portions 822b and 822c can have a high conductivity. In this example the innermost transfer layer portion 822a or the inner layer composite could include for example aluminum while the outwardly disposed transfer layer portion 822d or the outer layer composite could contain chromium.

A sintering process can be carried out after each layer application operation, in which respect it can further be provided that the sintering temperature and the sintering time are varied for each layer application operation.

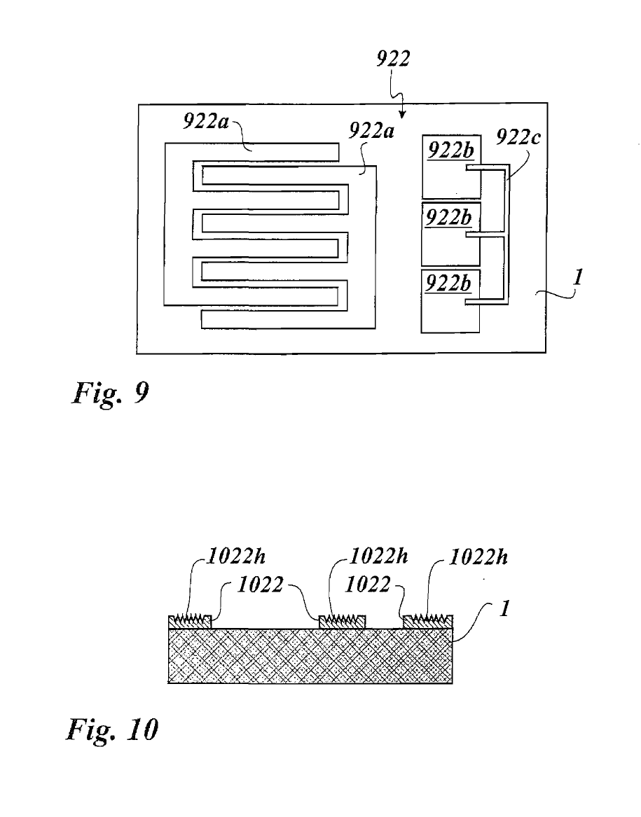

FIG. 9 now shows a plan view of a ninth embodiment which for example illustrates the possible configuration options of the process according to the invention.

Three transfer layer portions 922a through 922c which give conductor tracks 922 are successively transferred on to the carrier substrate 1. In the FIG. 5 embodiment the transfer layer portions 922a and 922b are in one plane, and equally the regions of the transfer layer portion 922c which do not cover over regions of the transfer layer portions 922b. The transfer layer portions 922b may for example be electrode layers. The transfer layer portion 922c can be conductor tracks which electrically connect the transfer layer portions 922b together. The transfer layer portions 922b and 922c can be made from different materials so that the material properties can be optimally adapted to the functions of ‘electrode’ and ‘line connection’.

The transfer layer portion 922a can form for example a capacitor or an antenna arrangement to perform an additional function, for example a capacitor or an antenna for an RFID chip integrated into the structure. For example the material and/or the cross-sectional structure and/or the surface structure of the transfer layer portion 922a can be optimised for that function. A surface structure which involves multiple subdivision can for example be of a substantially larger surface area than a smooth surface structure and therefore can have better electrical conductivity for high frequencies, that is to say in regard to making use of what is referred to as the skin effect.

FIG. 10 now shows a further embodiment in which electrode layers 1022 are applied by embossing on the carrier substrate 1, the electrode layers 1022 being personalised. Personalisation is effected after transfer of the electrode layer 1022 by embossing a surface profile, for example a hologram, into the surface of the electrode layer 1022. Personalisation can be provided for example to apply a tamper-proof authenticity certificate.

1. A process for the production of structures on a substrate, wherein
at least one transfer layer is transferred completely or region-wise on to the surface of the substrate by an embossing film, and wherein the transfer layer has regions in which the transfer layer contains particles and a binding agent and then open pores are produced in the transfer layer transferred on to the substrate, by the binding agent being expelled and porous structures thereby being produced on the substrate.

2. A process as set forth in claim 1, wherein a sintering process is carried out after transfer of the at least one transfer layer or between two successive embossing operations.

3. A process as set forth in claim 2, wherein the two or more sintering processes are performed at differing temperature and/or residence time.

4. A process as set forth in claim 3, wherein the sintering temperature is set in the range of between 300° C. and 800° C.

5. A process as set forth in claim 4, wherein the sintering temperature is set in the range of between 450° C. and 550° C.

6. A process as set forth in claim 1, wherein the binding agent is chemically expelled after the transfer of the at least one transfer layer or between two successive embossing operations.

7. A process as set forth in claim 1, wherein at least one filler is introduced into the open pores of the transfer layer transferred on to the substrate.

8. A process as set forth in claim 7, wherein the filler is an electrically conductive or a semiconducting material.

9. A process as set forth in claim 7, wherein the filler is a catalytically acting material.

10. A process as set forth in claim 7, wherein the filler forms a layer on the surface of the pores, which does not completely fill up the pores.

11. A process as set forth in claim 1, wherein a porous, electrically conductive structure is produced, by a region of the transfer layer being transferred completely or region-wise by the embossing film on to the surface of the substrate, in which the transfer layer contains electrically conductive particles besides the binding agent as the particles and then open pores are produced in the transfer layer transferred on to the substrate, by the binding agent being expelled and by porous electrically conductive structures thereby being produced on the substrate.

12. A process as set forth in claim 1, wherein a porous, electrically conductive structure is produced, by the at least one transfer layer being in the form of an electrically non-conducting transfer layer and being transferred completely or region-wise by the embossing film on to the surface of the substrate, open pores are produced in the transfer layer transferred on to the substrate, by the binding agent being expelled, and then an electrically conductive or an electrically semiconducting material is introduced as filler into the open pores.

13. A process as set forth in claim 1, wherein the geometrical structure and/or a conductivity structure of the structure is or are set by the configuration of the embossing film and/or an embossing punch.

14. A process as set forth in claim 1, wherein the structures are produced in more than one embossing step.

15. A process as set forth in claim 14, wherein transfer layers of different material and/or involving different electrical conductivity and/or of different geometrical structure and/or of a different cross-sectional profile are successively transferred.

16. A process as set forth in claim 15, wherein a conductivity gradient is produced by transferring two or more transfer layers in the structure.

17. A process as set forth in claim 1, wherein the adhesion of the structure is locally varied by transferring two or more transfer layers.

18. A process as set forth in claim 1, wherein the structure is embossed thereon with at least one protective layer.

19. A process as set forth in claim 1, wherein a transfer layer is applied as a concluding layer having an optically variable element.

20. A process as set forth in claim 1, wherein the substrate is an inorganic material, in particular a silicon wafer.

21. An embossing film for producing structures on substrates, wherein the embossing film has at least one transfer layer having regions in which the transfer layer contains particles and a binding agent, wherein open pores can be produced in the transfer layer by expelling the binding agent to produce porous structures.

22. An embossing film as set forth in claim 21, wherein the at least one transfer layer is formed from a mixture of particles and the binding agent.

23. An embossing film as set forth in claim 22, wherein the particles are electrically conductive particles.

24. An embossing film as set forth in claim 23, wherein the electrically conductive particles are metal particles.

25. An embossing film as set forth in claim 23, wherein the electrically conductive particles are carbon nanotubes.

26. An embossing film as set forth in claim 23, wherein the electrically conductive particles are particles of at least one electrically conductive polymer.

27. An embossing film as set forth in claim 22, wherein the particles are semiconducting particles.

28. An embossing film as set forth in claim 27, wherein the semiconducting particles are TiO₂ particles.

29. An embossing film as set forth in claim 27, wherein the semiconducting particles are particles of at least one semiconducting polymer.

30. An embossing film as set forth in claim 22, wherein the particles are electrically non-conducting particles.

31. An embossing film as set forth in claim 22, wherein the particles are catalytically acting particles.

32. An embossing film as set forth in claim 21, wherein the particles are of approximately equal dimensions.

33. An embossing film as set forth in claim 21, wherein the particles are of different dimensions.

34. An embossing film as set forth in claim 21, wherein the concentration by volume of the particles in the at least one transfer layer is not constant.

35. An embossing film as set forth in claim 21, wherein the binding agent can be expelled by a temperature process.

36. An embossing film as set forth in claim 21, wherein the binding agent can be expelled by a chemical process.

37. An embossing film as set forth in claim 21, wherein the embossing film has one or more release layers.

38. An embossing film as set forth in claim 21, wherein the embossing film has one or more priming layers.
